(19) United States
(12) Patent Application Publication
(10) Pub. No.: US 2020/0100428 A1
(43) Pub. Date: Apr. 2, 2020

(54) Harvesting Head Monitoring Using Crop Amount Deviations

(71) Applicant: Deere & Company, Moline, IL (US)

(72) Inventors: Noel W. Anderson, Fargo, ND (US); Cristian Dima, St. Ingbert/Rohrbach (DE); Dohn W. Pfeiffer, Bettendorf, IA (US)

(21) Appl. No.: 16/392,193

(22) Filed: Apr. 23, 2019

Related U.S. Application Data
(60) Provisional application No. 62/737,906, filed on Sep. 27, 2018.

(51) Int. Cl. A01D 41/127; A01D 41/06

(52) U.S. Cl. CPC A01D 41/127; A01D 41/06

(57) ABSTRACT

A system for assessing the performance of a harvesting head for harvesting crops from a field includes a first sensor for sensing an expected amount of crop within the harvesting head, a second sensing arrangement for sensing an amount of crop within the harvesting head, and an electronic control unit. The electronic control unit compares the expected amount of crop with the sensed amount of crop, and provides an output signal indicating a malfunction of the harvesting head in case the expected amount of crop deviates from the sensed amount of crop.

### FIELD OF THE INVENTION

The present invention relates to a system and a method for assessing the performance of a harvesting head for harvesting crops from a field.

### BACKGROUND OF THE INVENTION

Harvesting heads are used in agriculture to harvest crops grown on a field. The crop is collected and optionally fed into the harvesting machine for further processing. Dependent on the type of crop, different types of harvesting heads can be used. For grain harvesting, platforms are used, having a cutter bar for cutting the crop and a transverse conveyor like a cross auger or draper belt for feeding the crop to the center of the harvesting head from where it is fed into a feederhouse of a combine. Such platform harvesting heads can also be used for cutting and swathing the grain or other crop like grass for later collection. Swathed crop is collected by a pick-up and corn ears are harvested by a corn head with snapping rollers or a whole-plant mowing device. These are just some examples for harvesting heads used in agriculture.

While automation of harvesting machines, in particular combines, is relatively mature, operation of the harvesting head is presently left up to the operator of the harvesting machine. The operator needs to continuously watch whether the crop is taken up or cut properly and whether transverse feeding is also performed as desired. Disturbances of crop collection and feeding can happen due to numerous reasons, for example due to exceeding a useful forward speed and thus overloading the cross conveyor due to crop build-up, due to weeds wrapping around harvesting head parts or due to the cutter bar being too high over ground or penetrating into the earth. The duty of watching the crop flow into and within the harvesting head is quite burdensome for the operator.

In the art, some proposals have been made for an electronic perception of crop feeding problems in a harvesting head, generally using a camera and an image processing system for detecting interferences in a crop collection system and monitoring crop flow in a crop gathering device (DE 102016202627 A1, U.S. Pat. No. 9,928,606 B2, US 2018/084719 A1). Optical surveillance of crop flow in a harvesting head may be challenging because the camera would need to be mounted in front of the harvesting head, requiring a drone or a rod system for holding the camera, in order to obtain useful images. The present invention intends to overcome this and other problems.

### SUMMARY OF THE INVENTION

In accordance with one aspect of the invention, a system for assessing the performance of a harvesting head for harvesting crops from a field comprises a first sensing arrangement configured to sense a value representing an expected amount of crop within the harvesting head, a second sensing arrangement configured to sense a value representing an amount of crop within the harvesting head, and an electronic control unit connected to the first sensing arrangement and to the second sensing arrangement and configured to compare a value regarding an expected amount of crop within the harvesting head, which expected amount is calculated based upon the signal from the first sensing arrangement, with a sensed amount of crop within the harvesting head, which sensed amount is calculated based upon the signal from the second sensing arrangement, and to provide an output signal indicating a malfunction of the harvesting head in case the expected amount of crop within the harvesting head deviates from the sensed amount of crop within the harvesting head more than a threshold value.

In other words, the system on one hand senses, with a first sensing arrangement, in a predictive manner the amount, in particular at least one of volume or weight that is expected to be within the harvesting head at a certain point of time (which lies, at the time of obtaining and storing the signal from the first sensing arrangement in the future). Once this certain point of time has come, the (sensed) amount of crop within the header is sensed with a second sensing arrangement and compared by an electronic control unit with the expected amount of crop. In case that these two values are at least approximately or within a predetermined threshold band the same, one can assume that the harvesting head is operating properly. On the other hand, if the two values differ more than the predetermined threshold band, one can assume a malfunction of the header. This can be for example, in case that the expected amount is more than the sensed amount, be due to a cutting arrangement error of the harvesting head (cutting height too large or cutter bar blocked with crop or not moving at all) and in case that the expected amount is less than the sensed amount, be due to a feeding error within the harvesting head (crop building up in a conveyor). In both cases, an output signal indicating a malfunction of the harvesting head is given by the electronic control unit. This output signal can be simply given via a user interface to an operator allowing him to correct the problem on his end or be used for automatic correction of the problem, by automatic altering a work parameter of the harvesting machine, like altering the cutting height or reducing the forward speed.

In a preferred embodiment, the first sensing arrangement is configured to sense amounts of crop assigned to different zones across the width of the harvesting head, the second sensing arrangement is configured to sense amounts of crop assigned to different zones across the width of the harvesting head and the electronic control unit is configured to calculate expected amounts of crop within the harvesting head for the different zones and to compare the expected amounts with the sensed amounts for the respective, different zones and to provide an output signal indicating a malfunction of the harvesting head in case the expected amount of crop within at least one zone across the harvesting head deviates more than a threshold value from the sensed amount of crop within at least one zone of the harvesting head. Thus, the expected and sensed amount of crop are provided by the first and second sensing arrangements in a separate manner for a number of zones over the width of the harvesting head. This improves the accuracy and reliability of the system.

The electronic control unit can be configured to receive a ground speed signal regarding the ground speed of the harvesting head in a forward direction and a feeding speed signal regarding the speed with which crop is fed through and/or out of the harvesting head and to calculate the value regarding the expected amount of crop within the harvesting head based upon the first sensor value, the ground speed signal, and the feeding speed signal.

The first sensing arrangement can comprise at least one of a camera and an image processing system and a lidar system.

The second sensing arrangement can comprise a sensor for sensing at least one of the weight and volume of the crop within the harvesting head. The first sensing arrangement can also sense one of weight and volume of the crop to be harvested.

The electronic processing unit can be configured to calculate one of the weight of the crop and the volume of the crop based on a value of the crop sensed by the second sensing arrangement and based on at least one parameter, the at least one parameter stored in a memory or collected by a sensor. If the first sensing arrangement senses one of weight and volume of the crop to be harvested, the electronic processing unit can analogously be configured to calculate one of the volume of the crop and the weight of the crop based on a value of the crop sensed by the first sensing arrangement and based on a parameter, the at least one parameter stored in a memory or collected by a sensor.

The second sensing arrangement can comprise a sensor for sensing at least one of a weight of crop on a conveyor and a sensor for sensing a torque for driving a conveyor conveying crop in the harvesting head.

The second sensing arrangement can be configured to at least one of sense amounts of crop received (taken up from the field) in the different zones across the width of the harvesting head and sense amounts of crop contained (taken up from the field plus crop received from the side) in the different zones across the width of the harvesting head.

The electronic control unit can be configured to compare the amounts of crop expected to be received in the different zones across the width of the harvesting head sensed by the first sensing arrangement with the amounts of crop received in the different zones across the width of the harvesting head sensed by the second sensing arrangement. Thus, both sensing arrangements sense the incoming crop in the different zones and their signals are directly compared.

The electronic control unit can in another embodiment be configured to integrate the amounts of crop expected to be received in the different zones across the width of the harvesting head sensed by the first sensing arrangement over the width of the harvesting header and to compare the integrated amounts of crop with the amounts of crop contained in the different zones across the width of the harvesting head sensed by the second sensing arrangement. In this embodiment, it is calculated how much crop should be contained in each zone, based on the signals of the first sensing arrangement, by integrating the incoming crop amounts over the width of the header and considering the respective forward speed of the header and transverse feeding speeds and output speeds of the header, as described above. These amounts are compared with the amounts signaled by the second sensing arrangement, representing comparable values.

In another embodiment, the electronic control unit is configured to compare the amounts of crop expected to be received in different zones across the width of the harvesting head sensed by the first sensing arrangement with respective parts of the amounts of crop contained in the different zones across the width of the harvesting head sensed by the second sensing arrangement assigned to the respective zones. In this embodiment, it is sensed how much crop is received within each zone, based on the signals of the first sensing arrangement. The signals of the second sensing arrangement, representing integrated values for the width of the harvesting head, are differentiated to calculate the received amounts, and the latter value is compared with the amounts signaled by the first sensing arrangement, representing comparable values.

In a possible embodiment, the first sensing arrangement and the second sensing arrangement share at least one sensor. This can be in particular one or more cameras with an image processing system, looking to the field in front of the harvesting head to determine the expected amount of crop to be received and also viewing into the header to determine the amount of crop present therein. In another embodiment, different sensors are used by the first and second sensing arrangements.

### BRIEF DESCRIPTION OF THE DRAWINGS

FIG. 1 is a plan view of a combine harvester and a harvesting head with a system for assessing the performance of the harvesting head.

FIG. 2 is a plan view of the combine harvester and the harvesting head—with left and right side endless conveyor belts of the harvesting head removed.

FIG. 3 is a schematic diagram of the system for assessing the performance of the harvesting head combined with a fragmentary front view of the endless belt conveyors, rollers, and forward roller mounts of the harvesting head taken at section line 3-3 in FIG. 2.

FIG. 4 is a schematic top view of the harvesting head and the feederhouse.

FIG. 5 is a flow diagram according to which the electronic control unit of the system operates during harvesting.

### DETAILED DESCRIPTION

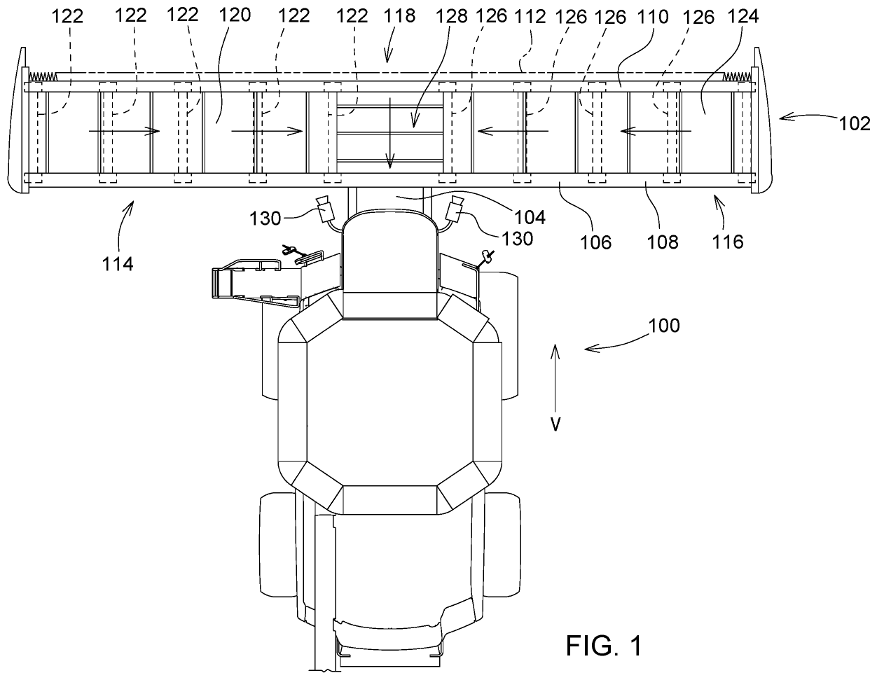

Referring to FIG. 1, an agricultural harvester 100 (shown herein as a combine harvester) supports a row independent harvesting head 102 (shown herein as a draper platform) on a feederhouse 104, wherein the feederhouse 104 is fixed to a forward end of the agricultural harvester 100 and extends forward therefrom. The harvesting head 102 comprises a frame 106 that extends laterally and perpendicular to the direction of travel “V” of the agricultural harvester 100 as it travels through the field harvesting crop. The frame 106 includes a rear transverse frame member 108 and a forward transverse frame member 110. Each of these frame members extends substantially over the entire width of the harvesting head 102. The harvesting head 102 further comprises a reciprocating knife 112 that extends laterally and perpendicular to the direction of travel “V” and is fixed to a forward edge of the frame 106, in particular to forward transverse member 110. The reciprocating knife 112 extends substantially over the entire width of the harvesting head 102.

The harvesting head 102 further comprises three endless belt conveyors, a left side endless belt conveyor 114, a right side endless belt conveyor 116, and a center endless belt conveyor 118. The left side endless belt conveyor 114 comprises an endless belt 120 and five rollers 122 about which the endless belt 120 circulates. At least one of these rollers 122 is driven by a motor (not shown) to cause the upper surface of the endless belt 120 to travel inwardly toward a central region of the harvesting head 102. This is indicated by the arrow superimposed on the surface of the endless belt 120 in FIG. 1. The right side endless belt conveyor 116 comprises an endless belt 124 and five rollers 126 about which the endless belt 124 circulates. At least one of the rollers 126 is driven by a motor (not shown) to cause the upper surface of the endless belt 124 to travel inwardly toward a central region of the harvesting head 102. This is indicated by the arrows superimposed on the surface of the endless belt 124 in FIG. 1. The center endless belt conveyor 118 comprises an endless belt 128 that is supported on rollers (not shown) for circulating movement in a rearward direction, i.e. in a direction opposite to the direction of travel “V”, and as indicated by the arrow superimposed on the endless belt 128 in FIG. 1.

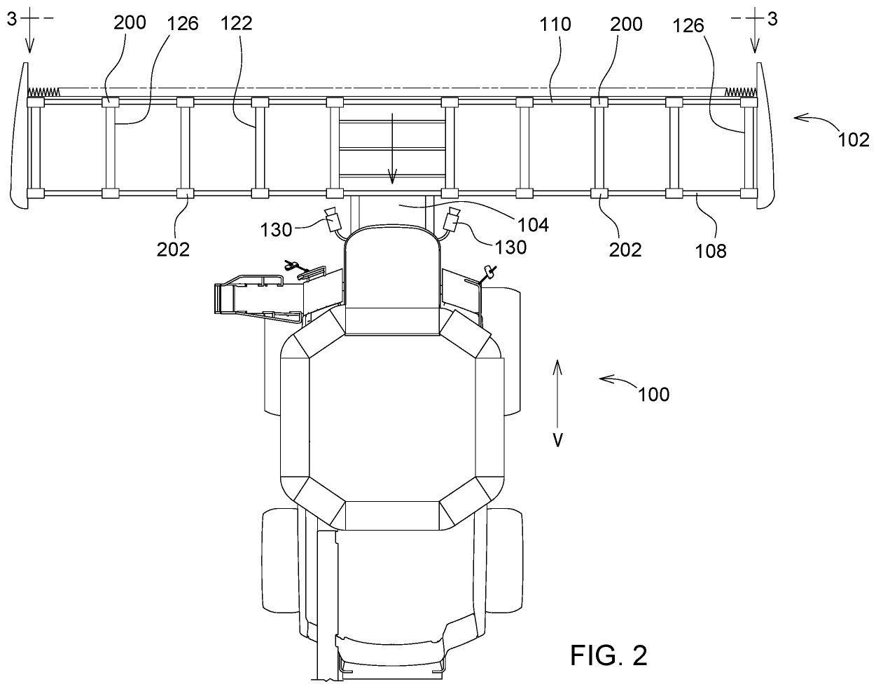

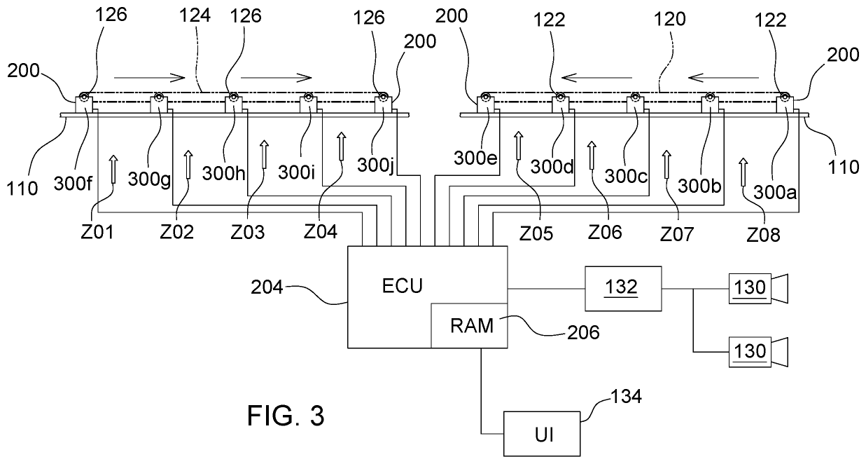

In FIG. 2, the endless belts 120, 124 have been removed for clarity of illustration. Each of the rollers 122 and 126 are supported at their forward ends on a corresponding forward roller mount 200. Each of the rollers 122, 126 are supported at their rear ends on a corresponding rear roller mount 202. The forward roller mounts 200 are fixed to the forward transverse frame member 110. The rear roller mounts 202 are fixed to the rear transverse frame member 108. Both the forward roller mounts 200 and the rear roller mounts 202 support the rollers 122, 126 to which they are coupled and permit the rollers 122, 126 to rotate with respect to the roller mounts 200, 202. Further, each of the ten forward roller mounts 200 comprises a built-in load sensor (FIG. 3) that generates a signal indicative of a vertical load placed upon each of the respective rollers 122, 126. By this arrangement, the weight of harvested crop on each of the rollers can be measured.

In FIG. 3, the front end of the left side endless belt conveyor 114 and the right side endless belt conveyor 116 is shown with the ten forward roller mounts 200 mounted upon the forward transverse frame member 110. The five rollers 122 support the endless belt 120 for recirculating movement about the rollers 122. The five rollers 126 support the endless belt 124 for recirculating movement about the rollers 126. The load sensors 300 (shown individually as load sensors 300a-300j) integrated into the forward roller mounts 200 are coupled to an electronic control unit (ECU) 204 that is configured to receive and process signals from the load sensors. The ECU comprises a digital microprocessor and a memory circuit. The memory circuit contains digital instructions. The digital instructions are executed by the digital microprocessor. The digital instructions configure the digital microprocessor to perform all the operations described herein.

ECU 204 is configured to determine the crop amount in each of eight zones (identified in FIG. 3 as zones Z01 to Z08) across substantially the entire width of the harvesting head 102. ECU 204 does this by determining the weight of cut crop material deposited on the endless belt 120 in the endless belt 124 in each of the eight zones.

For purposes of explanation, each of the ten load sensors 300 have been given individual designations. The load sensor 300 on the right outermost front roller mount 200 is identified as load sensor 300a. The next innermost load sensor 300 is load sensor 300b. The next innermost load sensor 300 is load sensor 300c, the next innermost load sensor 300 is load sensor 300d, and the next innermost load sensor 300 is load sensor 300e. The load sensor 300 on the left outermost front roller mount 200 is load sensor 300f. The next innermost load sensor 300 is load sensor 300g. The next innermost load sensor 300 is load sensor 300h. The next innermost load sensor 300 is load sensor 300i, and the next innermost load sensor 300 is load sensor 300j.

The ECU 204 is configured to periodically read the signals from all ten load sensors 300 and to store the signal levels of each of the ten load sensors in its random access memory (RAM) 206. This sampling is repeated at regular intervals during harvesting, on the order of every 100 ms.

The load signals from the ten load sensors indicate vertical loads equal to the weight of the conveyor belt (which is constant) plus the weight of the cut crop resting upon (and being carried by) the endless belts 120, 124. Crop is deposited upon the endless belts 120, 124 over substantially their entire width since the reciprocating knife extends over substantially the entire width of the harvesting head 102.

After all, it is apparent that the ECU 204 is connected to a number of load sensors 300 allowing to determine the amount (i.e. weight) of crop on the conveyor belts 120, 124 in the eight zones Z01-Z08. The load sensors 300 thus make up a sensing arrangement configured to sense a value representing an amount of crop within the harvesting head 102.

It should be noted that the amount of zones could be different from the number of eight shown in the FIGS. 1 to 3. For example, additional load sensors on the rollers supporting endless belt 128 of the center conveyor 118 could be provided, in order to obtain a crop amount signal also taking into account or sensing the additional amount of crop entering in front of the center conveyor 118. Also, the number of rollers 122 and sensors 300 could be increased or decreased.

For other types of harvesting heads 102, different sensing arrangements configured to sense the value representing the amount of crop within the harvesting head 102 could be used. For example, in a corn head with snapping rollers, the drive torque of conveyor chains feeding the ears to a transverse conveyor could be sensed for this purpose, or any other property indicating the throughput of the respective row unit (cf. US 2016/0084813 A1, US 2016/0084987 A1 and US 201/0164471 A1). For corn headers for cutting whole plants, the drive torque of the respective mowing and conveying drums and of the transverse conveyor drums and the drums feeding the crop into the infeed channel of a forage harvester could be sensed, and in a platform header with a cross auger, the auger could be split into separate sections with torque sensors in between. The amount of crop within the harvesting head 102 could also be sensed by a camera system looking into the header, like the cameras 130 with the image processing system 132 described below. The image processing system 132 could thus provide the ECU 204 with a signal on the amount (volume) of harvested crop within the harvesting head 102 over its width.

Further on, the ECU 204 is connected to (first) sensing arrangement configured to sense a value representing an expected amount of crop within the harvesting head 102 in a predictive manner. This sensing arrangement comprises two cameras 130 connected to an image processing system 132, which on its end is connected to the ECU 204. The cameras 130 are mounted on the roof of the cab of the harvesting machine 100 and look to the front. Based on the image of the cameras 130, the image processing system 132 derives a signal regarding the amount of crop standing or lying on the field in front of the harvesting header 102. The signals from the image processing system can be augmented or replaced by a lidar sensor, as described in DE 10 2008 043 716 A1 and U.S. Pat. No. 9,301,446 B2, the contents of both incorporated herein by reference. The sensing does not necessarily need to take place at the front of the harvesting header 102, but could take place at the side of the harvesting machine (cf. US 2015/0305238 A1).

Thus, the ECU 204 has on one hand information regarding the expected amount of crop from the (first) sensing arrangement and on the other hand information on the sensed, actual amount of crop within the harvesting header 102 from the (second) sensing arrangement configured to sense a value representing an amount of crop within the harvesting head 102. In a simple embodiment, the ECU 204 can compare the integrated respective crop amounts for the entire width of the harvesting head 102 (such an embodiment would not require the second sensing arrangement to be capable to measure separate values for the measurement zones Z01-Z08, but would also work with a single sensor for the entire throughput of the harvesting head 102, whereby such a sensor could sense the drive torque of a transverse conveyor, for example). In case that these values match, it can be assumed that the harvesting head 102 works as desired and in the other case the ECU 204 outputs an error message to be displayed on a user interface 134. In a more sophisticated embodiment, described below, this comparison is performed separately for the zones Z01-Z08.

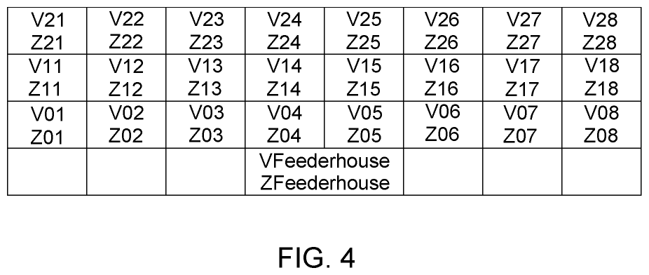

FIG. 4 is a schematic top view of the harvesting header 202 of FIGS. 1 to 3, with the forward direction to the top and the harvesting head 102 represented by the third boxed row, while crop ahead of the harvesting head 102 in the direction of travel is represented by the first and second boxed row. Crop exits the harvesting header 102 into the feederhouse 104 (fourth boxed row) from measurement zones Z04 and Z05. Two conveyors 114, 116 move harvested crop towards the feederhouse 104 at a target rate:

Z01->Z02->Z03->Z04 and Z08->Z07->Z06->Z05.

Over time with normal operation, each of the measurement zones Z01-Z08 will not have persistent large or small amounts of crop material relative to conservation of biomass (volume or as in this example, mass). That is, the amount of crop material (V0n) in a measurement zone (Z0n), in the next measurement period, t+1, should be equal to the amount of crop material (V0adj) brought into the measurement zone by the conveyor 114 or 116 plus crop material (V1n) brought in by harvesting the respective measurement zone less crop material (V0nout) conveyed out by the conveyor 114, 116. This means:

V0n(t+1)=V0n(t)+(V0adj(t)+V1n(t))−V0nout(t)

By defining measurement zones and measurement periods such that appropriately V0n(t)=V0nout(t), all current material should leave the measurement zone in the respective measurement period. The predictive equation becomes:

V0n(t+1)=0adj(t)+V1n(t)

With a specific example for Z02, V02(t+1)=V01(t)+V12(t). If the V0n(t)=V0nout(t) assumption is not held, V0n(t+1) will deviate significantly from what is expected. A differential deviation or a ratio of measured to predicted values can be used to signal a material accumulation or loss which may need to be mitigated. Action may be taken based on a single threshold or value or a pattern.

It should be mentioned that the previously described procedure can in another embodiment just calculate the amount of crop in each of the measurement zones based on the signals of the first sensing arrangement, considering the forward speed of the harvesting header 102 (which forward speed can be sensed with any suitable sensor, for example a sensor sensing the rotation speed of the harvesting machine 100 or a radar sensor interacting with the ground, or the forward speed of the harvesting header 102 is derived from drive signals controlling speed of the front wheels of the harvesting machine 100) and the transverse conveying speed of the conveyors 114, 116 (which transverse conveying speed can be sensed with any suitable sensor, for example an encoder or hall sensor sensing the rotation speed of the rollers 126 or a radar sensor interacting with the surface of the conveyors 114, 166 or the transverse conveying speed is derived from drive signals controlling speed of the rollers 126) and optionally the rearward feeding speed of the conveyor 118 and of the feederhouse 104 (which can be determined in a manner corresponding to the transverse conveying speed). Thus, the expected crop amounts for the measurement zones Z01-Z08 are calculated and compared with the corresponding values of the second sensing arrangement. The ECU 204 could also derive the incoming crop amount in each of the measurement zones Z01 to Z08 (as described in U.S. Pat. No. 9,668,406 B2, the contents of which incorporated herein by reference) and compare it with the expected crop amounts sensed by the first sensing arrangements for each measurement zone Z01-Z08.

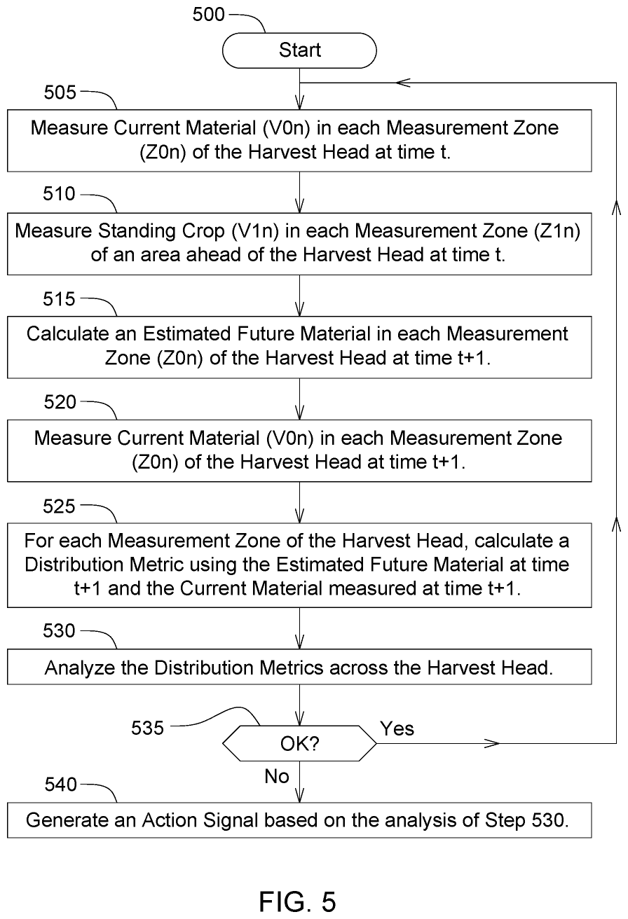

FIG. 5 is a flow chart for one example embodiment of a method according to which the ECU 204 can operate. After start in step 500, in step 505 the current material present in each measurement zone is sensed by the second sensing arrangement at a point in time t. In the next step 510, the amount of standing (or in case of lodged grain, lying) crop is sensed in an area ahead of the harvesting header 102 at the same time t. In the next step 515, an estimate future crop amount is calculated for each measurement zone, based on the result of steps 505 and 510. In the following step 520, the current material present in each measurement zone is sensed by the second sensing arrangement at a point in time t+1. In the following step 525, a distribution metric is calculated, based on the results of step 515 and 520. Thus, this distribution metric represents possible deviations between expected crop amounts and sensed crop amounts over the width of the harvesting head 102. Distribution metric examples are, without limitation, a ratio such as expected/measured, differential expected—measured or a classification with thresholds, like high, ok, low. The distribution metric is analyzed in step 530 for example, whether it represents a certain pattern of malfunction of the harvesting header at a present time or over a longer period) and in step 535 it is checked, whether it corresponds to a predetermined pattern (representing the normally expected crop flow in the harvesting head 102 including a predetermined hysteresis). If this is true, step 505 is executed again and otherwise step 540, in which the operator is alerted via the user interface 134 and/or a corresponding signal is sent by a wireless communication channel to a machine supervisor and/or a georeferenced logging of the distribution metrics takes place, which can include one or more images.

The sizes and positions of the measurement zones Z01-Z08 may be static in number and size or dynamic, in particular if the second sensing assembly allows a variation of the size of the measurement zones, what is the case if the second sensing assembly incorporates a contactless sensor for the crop volume in the harvesting header 102, like the cameras 130 with the image processing system 132. Number and size may vary for a variety of reasons not limited to crop type, crop stand condition (e.g. lodged or not), presence of crop across the entire harvesting head or estimated crop biomass or yield.

The interval between times t and t+1 may be fixed or may vary based on conditions not limited to crop type, crop stand condition (e-g. lodged or not), harvester forward speed, crop volume or mass flow rate.

The simplest estimate of the crop amount in the respective measurement zone is the sum of crop material from the adjacent header measurement zone and a crop zone ahead of the respective measurement zone, what is the case if the forward length of the crop zone equals to the width of the measurement zone (which is the same as the width of the crop zone) multiplied with the forward speed and divided by the conveyor speed.

In practice, crop may be compressed as it is harvested or conveyed. Thus one or more coefficients representing the compressibility of the crop (like moisture) may be used to compensate when material volume is being measured in steps 505 and 510. These one or more coefficients can be sensed by an appropriate sensor, like a moisture sensor for the crop in the feederhouse 104 or be stored in RAM 206 in a position referenced manner (collected during a previous harvest) and recalled based upon the actual position of the harvester 100 in the field.

In step 540, additionally or alternatively to an alert to the operator or supervisor, the ECU 204 can be configured to automatically take measures to remedy the detected problem by altering a work parameter of at least one of the harvesting machine 100 and the harvesting header 102, including one or more of changing harvester forward speed, change the transverse (auger or belt conveyor) speed of the harvesting header, change the position of the reel and altering reel tine engagement of the harvesting header in case of a detected jam. For example, if crop should build up and fall down from the front of knife 112, the reel might not be adjusted in a sufficient height for delivery of crop to the transverse conveyor and this the reel should be lowered, or the knife 112 needs (in case of an extendable knife 112) to be extended or the harvesting head 102 can be lowered. In some example embodiments, other sensor inputs are used to disambiguate causes and solutions. In practice, sensing and responding may be implemented as a rule-based system, formulas, neural network, or any other suitable way of analyzing sensor data and generating a signal(s) that controls an actuator(s). In this context, reference is made to the disclosures of DE 10 2018 206 507 A1 and Indian patent application 201821013464, both incorporated herein by reference.

As used herein, “at least one of A, B, and C” means “A, B, C, or any combination of A, B, and C.”

1. A harvesting head monitoring system for assessing the performance of a harvesting head for harvesting crops from a field, the system comprising:
a first sensing arrangement configured to sense a value representing an expected amount of crop within the harvesting head;
a second sensing arrangement configured to sense a value representing an amount of crop within the harvesting head; and
an electronic control unit connected to the first sensing arrangement and to the second sensing arrangement, the electronic control unit configured to:
calculate an expected amount of crop within the harvesting head based on a signal received from the first sensing arrangement;
calculate a sensed amount of crop within the harvesting head based on a signal received from the second sensing arrangement;
compare the calculated expected amount of crop within the harvesting head with the calculated sensed amount of crop within the harvesting head; and
provide an output signal indicating a malfunction of the harvesting head if the expected amount of crop within the harvesting head deviates from the sensed amount of crop within the harvesting head by more than a threshold value.

2. The harvesting head monitoring system of claim 1, wherein:
the first sensing arrangement is further configured to sense values representing expected amounts of crop within different zones across the width of the harvesting head;
the second sensing arrangement is further configured to sense values representing amounts of crop within different zones across the width of the harvesting head; and
the electronic control unit is further configured to:
calculate an expected amount of crop within a zone for a plurality of different zones of the harvesting head based on signals received from the first sensing arrangement;
calculate a sensed amount of crop within a zone for a plurality of different zones of the harvesting head based on signals received from the second sensing arrangement;
compare the calculated expected amount with the calculated sensed amount for the respective different zones; and
provide an output signal indicating a malfunction of the harvesting head if the calculated expected amount of crop within at least one zone across the harvesting head deviates more than a threshold value from the calculated sensed amount of crop within that zone.

3. The harvesting head monitoring system of claim 1, wherein the electronic control unit is further configured to receive a ground speed signal regarding the ground speed of the harvesting head in a forward direction and a feeding speed signal regarding the speed with which crop is fed at least one of through the harvesting head and out of the harvesting head and to calculate the expected amount of crop within the harvesting head based upon the signal received from the first sensing arrangement, the ground speed signal, and the feeding speed signal.

4. The harvesting head monitoring system of claim 1, wherein the first sensing arrangement comprises at least one of a camera with an image processing system and a lidar system.

5. The harvesting head monitoring system of claim 1, wherein the second sensing arrangement comprises a sensor for sensing at least one of the weight and volume of the crop within the harvesting head.

6. The harvesting head monitoring system of claim 5, wherein the electronic control unit is configured to calculate one of the weight of the crop and the volume of the crop based on a value of the crop sensed by the second sensing arrangement and based on at least one parameter, the at least one parameter stored in a memory or collected by a sensor.

7. The harvesting head monitoring system of claim 5, wherein the electronic control unit is configured to calculate one of the weight of the crop and the volume of the crop based on a value of the crop sensed by the first sensing arrangement and based on at least one parameter, of the at least one parameter stored in a memory or collected by a sensor

8. The harvesting head monitoring of claim 5, wherein the second sensing arrangement comprises a sensor for sensing at least one of a weight of crop on a conveyor and a sensor for sensing a torque for driving a conveyor conveying crop in the harvesting head.

9. The harvesting head monitoring system of claim 2, wherein the second sensing arrangement is configured to sense at least one of amounts of crop received in the different zones across the width of the harvesting head and amounts of crop contained in the different zones across the width of the harvesting head.

10. The harvesting head monitoring system of claim 9, wherein the electronic control unit is configured to compare the amounts of crop expected to be received in the different zones across the width of the harvesting head sensed by the first sensing arrangement with the amounts of crop received in the different zones across the width of the harvesting head sensed by the second sensing arrangement.

11. The harvesting head monitoring system of claim 9, wherein the electronic control unit is configured to integrate the amounts of crop expected to be received in the different zones across the width of the harvesting head sensed by the first sensing arrangement over the width of the harvesting header and to compare the integrated amounts of crop with the amounts of crop contained in the different zones across the width of the harvesting head sensed by the second sensing arrangement.

12. The harvesting head monitoring system of claim 9, wherein the electronic control unit is configured to compare the amounts of crop expected to be received in different zones across the width of the harvesting head sensed by the first sensing arrangement with respective parts of the amounts of crop contained in the different zones across the width of the harvesting head sensed by the second sensing arrangement assigned to the respective zones.

13. The harvesting head monitoring system of claim 1, wherein the first sensing arrangement and the second sensing arrangement share at least one sensor.

14. The harvesting head monitoring system of claim 1, wherein the electronic control unit is connected to at least one of a user interface and an actuator for adjusting a work parameter of at least one of the harvesting header and a harvesting machine supporting the harvesting header.

15. The harvesting head monitoring system of claim 1, wherein the system is included in a harvesting machine.
